(19) United States
(12) Patent Application Publication
(10) Pub. No.: US 2011/0003216 A1
(43) Pub. Date: Jan. 6, 2011

(54) FUEL CELL AND FUEL CELL SYSTEM

(75) Inventor: Atsuhito Yoshizawa, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/665,833

(22) PCT Filed: Jul. 24, 2008
(86) PCT No.: PCT/JP2008/063717

§ 371 Date: Dec. 21, 2009

(30) Foreign Application Priority Data
Aug. 2, 2007 (JP) 2007-201793
Jun. 20, 2008 (JP) 2008-162304

(51) Int. Cl. H01M 8/06

(52) U.S. Cl. 429/413

(57) ABSTRACT

The fuel cell according to the present invention includes a membrane electrode assembly, two diffusion layers, an oxygen supplying layer, a water-absorbing layer, and a current collector. An end portion of the water-absorbing layer is located on a plane including an opening portion or on the fuel cell-side with respect to the plane. A length from one end portion to the other end portion of a part of the oxygen supplying layer which contacts the water-absorbing layer in a cross section of the fuel cell taken along a surface which includes the water-absorbing layer and which is perpendicular to the plane is shorter than a length from one end portion to the other end portion of the water-absorbing layer including a part of the water-absorbing layer which contacts the oxygen supplying layer in the cross section.

### TECHNICAL FIELD

The present invention relates to a fuel cell and a fuel cell system which include an oxygen supplying layer serving both as a supply path along which oxygen is supplied to a power generation layer member and as a discharge path along which water molecules generated by the power generation layer member are discharged. In particular, the present invention relates to a fuel cell capable of efficiently removing not required liquid water from a power generation layer member and a fuel cell system using the fuel cell.

### BACKGROUND ART

Fuel cell systems are available which include a sealed fuel gas supplying space located on one surface of a power generation layer member and an oxygen supplying layer located on the other surface of the power generation layer member. The power generation layer member takes in hydrogen ions from the fuel gas supplying space and causes the hydrogen ions to react with oxygen on the oxygen supplying layer-side surface. The oxygen supplying layer serves both as a supply path along which a required amount of oxygen is supplied to the surface of the power generation layer member and as a diffusion (or forced discharge) path along which water molecules generated by the power generation layer member are carried out.

U.S. Pat. No. 6,423,437 illustrates a fuel cell system in which the fuel cells each including a power generation layer member are stacked and connected together in series. The fuel cell system described in U.S. Pat. No. 6,423,437 takes in oxygen from the atmosphere through an opening in a side surface of each fuel cell. The fuel cell system evaporates and diffuses moisture in the oxygen supplying layer to the atmosphere through the same opening.

Furthermore, the power generation layer member is a membrane electrode assembly including a polymer electrolyte membrane and porous, conductive catalyst layers formed on the opposite surfaces of the polymer electrolyte membrane. A side surface of a three-dimensionally air-permeable plate-like oxygen supplying layer which faces the opening is open to the atmosphere. Oxygen taken in through the side surface of the oxygen supplying layer is three-dimensionally diffused through the oxygen supplying layer. The oxygen is thus supplied to the entire surfaces of the membrane electrode assembly through one side of the oxygen supplying layer, that is, a bottom surface thereof. Water molecules generated by the membrane electrode assembly are taken into the oxygen supplying layer as water vapor. The water vapor then moves to the side surface of the oxygen supplying layer according to the concentration gradient of the water vapor. The water vapor is then diffused to the atmosphere through the opening.

Japanese Patent Application Laid-Open No. 2005-174607 discloses a fuel cell system in which the air is forcibly fed from one side surface of the oxygen supplying layer to the other side surface thereof for circulation. According to Japanese Patent Application Laid-Open No. 2005-174607, a separator including a groove-like air channel formed therein is located over the oxygen supplying layer; the air channel penetrates the opposite side surfaces of the fuel cell. The structure density of the oxygen supplying layer contacting the air channel is varied in a thickness direction to increase the structure densities of surface layers contacting the air channel and the membrane electrode assembly, respectively, above that of an intermediate layer. The water retentivity of the intermediate layer is thus enhanced.

Japanese Patent Application Laid-Open No. 2002-110182 discloses a fuel cell system including a catalyst layer formed on a polymer electrolyte membrane-side surface of an oxygen diffusion layer located over the power generation layer member. The fuel cell system described in Japanese Patent Application Laid-Open No. 2002-110182 depends on natural diffusion to passively supply oxygen to and discharge water vapor from the oxygen diffusion layer. Countless through-holes of diameter of not more than 100 μm are formed at a density of 400 per mm² so as to penetrate the oxygen diffusion layer in the thickness direction. This improves the diffusion capability in the thickness direction. Each of the through-holes (which is conical) has a sectional area increasing from the polymer electrolyte membrane-side surface to the opposite surface. The through-holes thus increase the contact areas of the polymer electrolyte membrane-side surface and the strength of the oxygen diffusion layer, while reducing passage resistance to oxygen and water vapor.

Japanese Patent Application Laid-Open No. 2005-353605 describes a fuel cell system including a water-absorbing material in an oxygen electrode and utilizing a capillary phenomenon in the oxygen electrode to suck out water to inhibit possible flooding.

Fuel cell systems carried integrally with apparatuses desirably depend on the natural diffusion to passively supply the oxygen to and discharge the water vapor from the oxygen diffusion layer. Such fuel cell systems desirably eliminate the need to externally supply power upon starting the apparatus. This is because the use of an atmosphere circulating mechanism and a blower increases the number of components required, disadvantageously preventing a reduction in the size and weight of the fuel cell systems. The fuel cell system illustrated in Japanese Patent Application Laid-Open No. 2005-174607 is based on such an atmosphere circulating mechanism and a blower.

However, if the fuel cell system depends totally on the natural diffusion to supply the oxygen to and discharge the water vapor from the oxygen diffusion layer, since the oxygen and water vapor move in completely opposite directions, an increase in output current from the fuel cell system and thus in the amount of water vapor discharged may prevent the supply of the oxygen. In particular, if the fuel cells are stacked and the water vapor is discharged through the opening in the side surface of each of the fuel cells, the oxygen has difficulty reaching areas located away from the opening because the supply of the oxygen is obstructed by the flow of the water vapor traveling to the opening.

The obstructed oxygen supply to the power generation layer member reduces an electromotive force and thus the power generation efficiency of the fuel cells. The reduced power generation efficiency increases the amount of heat generated to further raise temperature. This increases the partial pressure of the water vapor while reducing the partial pressure of the oxygen, in the oxygen supplying layer, further preventing the oxygen supply to the power generation layer member.

Furthermore, the increased partial pressure of the water vapor in the oxygen supplying layer inhibits generated water from being evaporated from an interface of the power generation layer member. Thus, liquid water remains at the interface. As a result, the interface is locally covered with the liquid water and flooded. In the flooded area, the oxygen supply is disrupted to stop power generation. Consequently, in a non-flooded area, current density increases to reduce the electromotive force of the fuel cell. If the operation of the apparatus continues, the flooded area spreads to the area with the increased current density. Finally, the entire power generation layer member is flooded, thus completely stopping the power generation of the fuel cell.

Thus, for the passive type depending on the natural diffusion, compared to an active type that forcibly circulates the air through the oxygen supplying layer and forcibly discharges the water vapor from the oxygen supplying layer, a current value per unit surface area of the power generation layer member needs to be set to be extremely small. When the current value per unit surface area is set to be extremely small, the area of the power generation layer member is increased to increase the size of a power generation section. This may even make the passive fuel cell system larger than the active one.

In the fuel cell system illustrated in Japanese Patent Application Laid-Open No. 2005-174607, the density of the surface layer of the oxygen supply layer, contacting the power generation layer member, is set higher than that of the intermediate layer so that the liquid water at the interface of the power generation layer member is sucked up into the intermediate layer for vaporization and diffusion. However, the water vapor supplied to the intermediate layer remains therein to prevent the diffusion of the oxygen and the supply of the oxygen to the power generation layer member through the intermediate layer until the water vapor is discharged through the opposite surface layer with the increased density. The surface layer, which positively allows moisture to remain in the intermediate layer member, increases the vapor pressure of the intermediate layer to hinder the oxygen from reaching the power generation layer member.

The fuel cell system illustrated in Japanese Patent Application Laid-Open No. 2002-110182 is based on the passive type depending on the natural diffusion to improve the capability of discharging the moisture from the power generation layer member to the oxygen supplying layer. However, the moisture taken into the oxygen supplying layer is also moved, by the natural diffusion of the water vapor, through the oxygen supplying layer in the direction opposite to that in which the oxygen moves. That is, this fuel cell system does not facilitate the evaporation of the generated water from the power generation layer member by reducing the partial pressure of the water vapor in the oxygen supplying layer or facilitate the movement and diffusion of the oxygen through the oxygen supplying layer.

In the fuel cell system illustrated in Japanese Patent Application Laid-Open No. 2005-353605, the water-absorbing material surrounds the catalyst. Thus, the catalyst portion needs to be small, and the fuel cell system has difficulty exhibiting sufficient performance.

An object of the present invention is to provide a fuel cell which allows generated water resulting from power generation to be easily discharged from the oxygen supplying layer without depending on any active technique and which enables a high power generation efficiency to be stably maintained even with a high current value, and to provide a fuel cell system including the fuel cell.

### DISCLOSURE OF THE INVENTION

The present invention provides a fuel cell comprising a membrane electrode assembly comprising an electrolyte membrane and two catalyst layers located opposite each other across the electrolyte membrane, two diffusion layers located opposite each other across the membrane electrode assembly, an oxygen supplying layer contacting one of the two diffusion layers, a water-absorbing layer contacting the oxygen supplying layer, and a current collector contacting the oxygen supplying layer, wherein the fuel cell comprises:

an opening portion in a part of a side surface of the fuel cell which is parallel to a proton conduction direction of the electrolyte membrane,

the water-absorbing layer is provided between the oxygen supplying layer and the current collector,

an end portion of the water-absorbing layer is located on a plane including the opening portion or on the fuel cell-side with respect to the plane, and

a length from one end portion to the other end portion of a part of the oxygen supplying layer which contacts the water-absorbing layer in a cross section of the fuel cell taken along a surface which includes the water-absorbing layer and which is perpendicular to the plane is smaller than a length from one end portion to the other end portion of the water-absorbing layer including a part of the water-absorbing layer which contacts the oxygen supplying layer in the cross section.

The length from one end portion to the other end portion of the part of the oxygen supplying layer which contacts the water-absorbing layer in the cross section can be equal to or greater than a length of the membrane electrode assembly in a direction perpendicular to the plane including the opening portion in the cross section.

The length from one end portion to the other end portion of the part of the oxygen supplying layer which contacts the water-absorbing layer in the cross section can be smaller than a length from one end portion to the other end portion of a part of the oxygen supplying layer which contacts the current collector in the cross section.

The present invention also provides a fuel cell system characterized by including a plurality of the fuel cells stacked therein.

The fuel cell according to the present invention allows generated water resulting from power generation to be easily discharged from the oxygen supplying layer without depending on any active technique and enables a high power generation efficiency to be stably maintained even with a high current value. Thus, the fuel cell according to the present invention can be used to provide a fuel cell system that can provide high power in spite of a small size and a light weight.

Further features of the present invention will become apparent from the following description of exemplary embodiments with reference to the attached drawings.

### BRIEF DESCRIPTION OF THE DRAWING

FIG. 1 is a perspective view illustrating a general configuration of a fuel cell system according to the present invention.

FIG. 2 is a sectional view of a membrane electrode assembly for use in the present invention, taken along a direction parallel to a proton conduction direction.

FIG. 3 is an exploded perspective view illustrating the configuration of a fuel cell according to the present invention.

FIGS. 4A, 4B and 4C are diagrams illustrating an oxygen supplying layer according to a first exemplary embodiment.

FIGS. 5A, 5B1, 5B2, 5C, 5D and 5E are diagrams illustrating the oxygen supplying layer and a water-absorbing layer according to the first exemplary embodiment.

FIGS. 6A, 6B and 6C are diagrams illustrating an oxygen supplying layer according to a second exemplary embodiment.

FIGS. 7A, 7B, 7C and 7D are diagrams illustrating the oxygen supplying layer and a water-absorbing layer according to the second exemplary embodiment.

FIGS. 8A, 8B and 8C are diagrams illustrating an oxygen supplying layer according to a third exemplary embodiment.

FIGS. 9A, 9B, 9C and 9D are diagrams illustrating the oxygen supplying layer and a water-absorbing layer according to the third exemplary embodiment.

FIGS. 10A, 10B and 10C are diagrams illustrating an oxygen supplying layer according to a fourth exemplary embodiment.

FIGS. 11A, 11B, 11C and 11D are diagrams illustrating the oxygen supplying layer and a water-absorbing layer according to the fourth exemplary embodiment.

FIG. 12 is a diagram illustrating a temporal variation in the cell voltage of the fuel cells in Example 1 and Comparative Example 1.

FIGS. 13A, 13B, 13C and 13D are diagrams illustrating an oxygen supplying layer and a water-absorbing layer in Comparative Example 1.

### BEST MODES FOR CARRYING OUT THE INVENTION

Exemplary embodiments of a fuel cell and a fuel cell system according to the present invention will be described below in detail with reference to the drawings.

The fuel cell and the fuel cell system described in the exemplary embodiments below generate power using fuel gas stored in a fuel tank. However, a liquid fuel such as methanol which contains hydrogen atoms may be stored in the fuel tank so that a required amount of liquid fuel reacts with fuel gas for reformation as required.

The fuel cell system described below in the exemplary embodiments can be used in portable electronic apparatuses, for example, digital cameras, digital video cameras, small-sized projectors, small-sized printers, and notebook personal computers. In this case, the fuel cell system can be independently used and removably installed in the apparatus, or a power generating portion of the fuel cell system alone can be incorporated into the electronic apparatus so that the fuel tank is removable.

The exemplary embodiments of the present invention are illustrated below.

### First Exemplary Embodiment

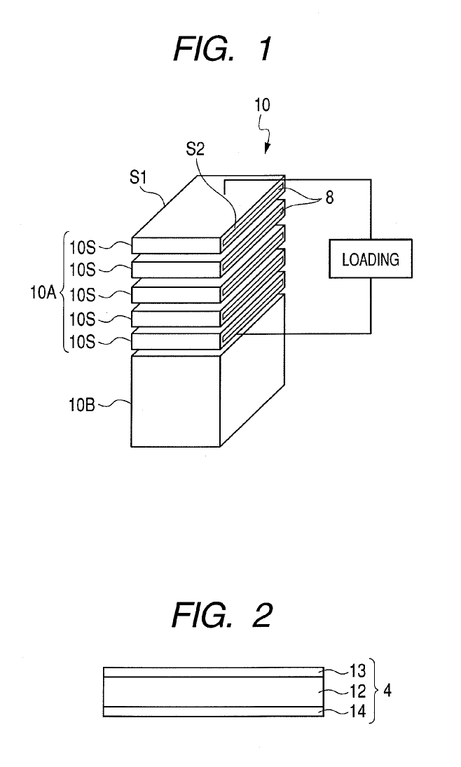

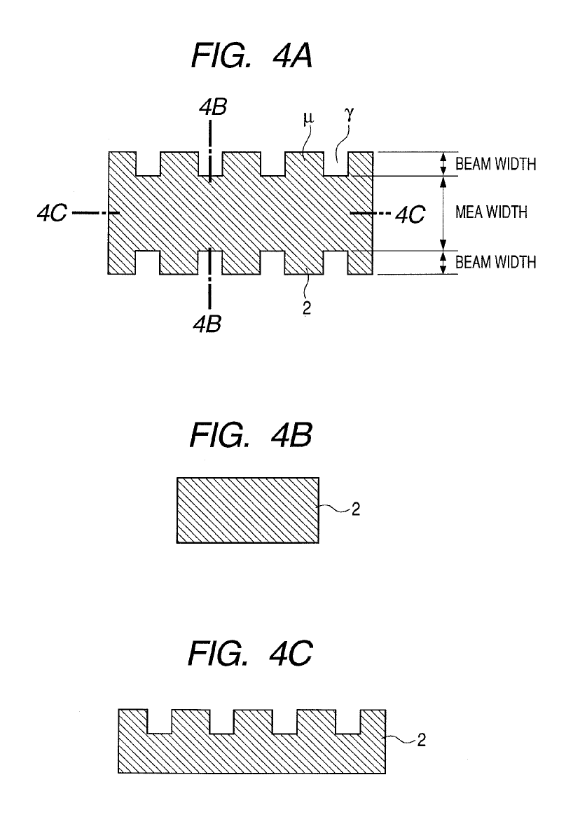

FIG. 1 is a perspective view illustrating a general configuration of a fuel cell system according to a first exemplary embodiment. FIG. 3 is an exploded perspective view illustrating the configuration of a fuel cell according to the first exemplary embodiment.

As illustrated in FIG. 1, a fuel cell system 10 includes a cell stack (fuel cell stack) 10A with the fuel cells 10S stacked and connected together in series. A fuel tank 10B is provided under the cell stack 10A to store and supply fuel gas to the fuel cells 10S. The cell stack 10A and the fuel tank 10B are connected together by a channel (not illustrated in the drawings) for the fuel gas. The fuel gas drawn out of the fuel tank 10B is adjusted to a pressure slightly higher than the atmospheric pressure and then supplied to each of the fuel cells 10S.

Each of the fuel cells 10S includes an opening portion 8 in side surfaces S1 and S2 of the fuel cell which correspond to end portion surfaces of the cell extending in a direction parallel to a proton conduction direction of an electrolyte membrane. More specifically, the opening portion 8 is formed in two side surfaces of an oxygen supplying layer which is a member constituting the fuel cell; the two side surfaces are parallel to the proton conduction direction.

The opening portion 8 functions as an air intake through which air in the atmosphere is taken into the fuel cells 10S by means of natural diffusion. As illustrated in FIG. 1, the fuel cell 10S generates power by allowing the fuel gas fed from the fuel tank 10B to act with oxygen in the air taken in through the opening portion 8. If the fuel cell is a rectangular parallelepiped, the cell can have the opening portion in each of the two opposite side surfaces.

As illustrated in FIG. 3, the fuel cell 10S according to the present exemplary embodiment includes at least an oxygen supplying layer 2, a water-absorbing layer 11, diffusion layers 3 and 5, a membrane electrode assembly (MEA) 4, a fuel supplying layer 6, a separator 7, a beam 15, an O ring 16, and a current collector 1. The oxygen supplying layer 2 contacts the diffusion layer 3 at a central portion thereof (a portion of the diffusion layer 3 which is not end portions thereof) and presses an electrolyte film in the membrane electrode assembly 4, the O ring 16, and the separator 7 at the end portions thereof via the beam 15. The membrane electrode assembly 4 and the separator 7 are thus appropriately sealed.

In the fuel cell 10S according to the present exemplary embodiment, each end portion of the water-absorbing layer is located on a plane including the opening portion 8 or on the fuel cell-side with respect to the plane.

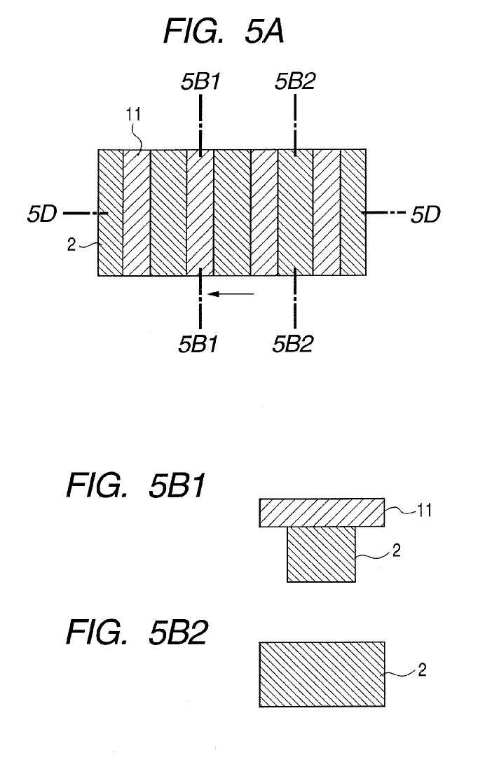

FIGS. 4A to 4C illustrate the oxygen supplying layer 2 according to the present exemplary embodiment. FIG. 4A is a projection view illustrating that the oxygen supplying layer 2 according to the present exemplary embodiment is irradiated with light from the direction of the separator 7. FIG. 4B is a sectional view (a cross section 4B-4B in FIG. 4) of a part of the oxygen supplying layer which contacts the water-absorbing layer; the sectional view is taken along a surface perpendicular to the plane including the opening portion. FIG. 4C is a sectional view (a cross section 4C-4C in FIG. 4) of the oxygen supplying layer 2 taken along a surface parallel to the plane including the opening portion and including a symmetry point of the oxygen supplying layer 2.

For the oxygen supplying layer 2, an oxygen supplying layer precursor layer B is obtained from an oxygen supplying layer precursor layer A shaped like a rectangular parallelepiped, as follows. A plurality of areas enclosed by the following surfaces are cut from the parts of oxygen supplying layer precursor layer A other than those located opposite the membrane electrode assembly: a surface parallel to the plane including the opening portion, two surfaces which are perpendicular to the surface parallel to the plane including the opening portion and which are parallel to the proton conduction direction, and one side surface of the oxygen supplying layer precursor layer which is parallel to the opening portion. Then, the oxygen supplying layer 2 is obtained from the oxygen supplying layer precursor layer B as follows. A plurality of areas enclosed by the following surfaces are cut from the parts of oxygen supplying layer precursor layer B other than those located opposite the membrane electrode assembly: the surface parallel to the plane including the opening portion, the two surfaces which are perpendicular to the surface parallel to the plane including the opening portion and which are parallel to the proton conduction direction, and the other side surface of the oxygen supplying layer precursor layer which is parallel to the opening portion (this side surface lies opposite the above-described side surface). In the description, for convenience, the oxygen supplying layer precursor layer is conveniently assumed to be a rectangular parallelepiped but need not necessarily be such. If the oxygen supplying layer precursor layer is not a rectangular parallelepiped, the oxygen supplying layer is obtained by cutting a plurality of areas enclosed by the surface parallel to the plane including the opening portion, the two surfaces perpendicular to the surface parallel to the plane including the opening portion, and a surface of the oxygen supplying layer precursor layer which is closest to the opening portion. Furthermore, in the description, the oxygen supplying layer 2 is produced by cutting the appropriate areas from the oxygen supplying layer precursor layer. However, an oxygen supplying layer initially having the above-described structure may be used instead of producing the oxygen supplying layer 2 by cutting the appropriate areas from the oxygen supplying layer precursor layer. Here, the phrase “surface perpendicular to A” means that an angle to A is 90°±5°. In FIG. 4A, a portion γ and a portion μ adjacent to the portion γ, both of which are cut from the oxygen supplying layer precursor layer, are a part of a seal portion of an outer periphery of the cell. The O ring, which is the seal portion, is pressurized by foam metal via the beam, which is a supporting member. In this case, not all the end portions of the foam metal but only portions with a groove formed therein are cut off. Thus, the remaining portions allow the O ring to be pressurized via the beam portion, the supporting member. As a result, sufficient sealability can be ensured.

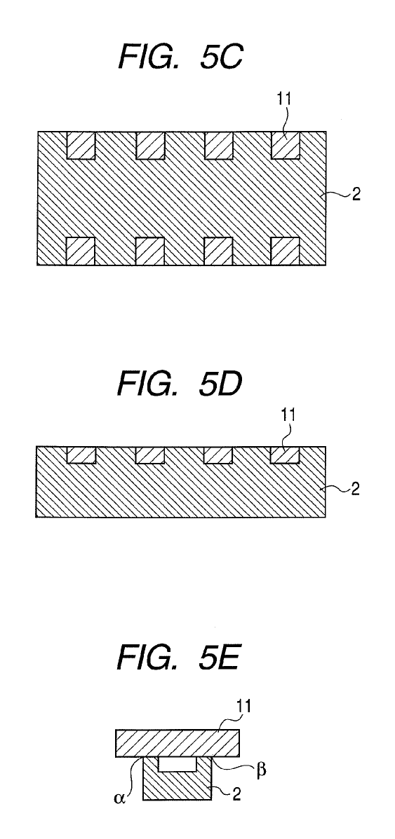

FIGS. 5A to 5D illustrate the oxygen supplying layer 2 and the water-absorbing layer 11 of the present exemplary embodiment. FIG. 5A is a projection view illustrating that the oxygen supplying layer 2 and the water-absorbing layer 11 are irradiated with light from the direction of the current collector 1. FIG. 5B1 is a sectional view of the oxygen supplying layer 2 and the water-absorbing layer 11 illustrated in FIG. 5A; the sectional view is taken along a surface (a cross section 5B1-5B1 in FIG. 5A) which includes the water-absorbing layer and which is perpendicular to the plane including the opening portion. FIG. 5B2 is a sectional view of the oxygen supplying layer 2 and the water-absorbing layer 11 illustrated in FIG. 5A; the sectional view is taken along a surface (a cross section 5B2-5B2 in FIG. 5A) which does not include the water-absorbing layer and which is perpendicular to the plane including the opening portion. FIG. 5C is a projection view illustrating that the oxygen supplying layer 2 and the water-absorbing layer 11 are irradiated with light from the direction of the diffusion layer 3. FIG. 5D is a sectional view of the oxygen supplying layer 2 and the water-absorbing layer 11 illustrated in FIG. 5A; the sectional view is taken along a surface (a cross section 5D-5D in FIG. 5A) which is parallel to the plane including the opening portion and which includes a symmetry point of the oxygen supplying layer 2.

With the oxygen supplying layer 2 structured as illustrated in FIG. 4A, the length from one end portion to the other end portion of a part of the oxygen supplying layer 2 contacting the water-absorbing layer 11 in the cross section of the fuel cell 10S taken along the surface perpendicular to the plane including the opening portion 8 is shorter than the length from one end portion to the other end portion of the water-absorbing layer including the part thereof contacting the oxygen supplying layer 2 in the cross section. That is, in this structure, the oxygen supplying layer 2 is not contacted with parts of one of proton-conduction-direction end portion surfaces of the water-absorbing layer 11 which end portion surface is closest to the oxygen supplying layer 2, the parts being other than the central portion of the water-absorbing layer 11. Evaporability can thus be improved. The fuel cell according to the present exemplary embodiment uses the oxygen supplying layer shaped as described above, as the oxygen supplying layer 2. Consequently, even the small-sized fuel cells enable the evaporability to be improved.

If the cross section 5B1-5B1 in FIG. 5A is as illustrated in FIG. 5E and the oxygen supplying layer 2 has parts not contacting the water-absorbing layer 11, between parts contacting the water-absorbing layer 11, then the length from one end portion to the other end portion of the part contacting the water-absorbing layer 11 is the length from a portion of the contacting part which is closest to one side of the opening portion to a portion of the contacting part which is closest to the other side of the opening portion (the length from a portion α to a portion β).

Furthermore, the length of the oxygen supplying layer 2 perpendicular to the plane including the opening portion in the cross section 5B1-5B1 in FIG. 5A can be equal to or greater than the length of the membrane electrode assembly 4 perpendicular to the plane including the opening portion in the same cross section. Here, the length of the membrane electrode assembly perpendicular to the plane including the opening portion refers to the maximum length of the membrane electrode assembly perpendicular to the plane including the opening portion in a perspective diagram obtained when the two catalyst layers in the membrane electrode assembly 4 are irradiated with light from the direction of the oxygen supplying layer 2.

Components of the fuel cell 10S will be described below.

The oxygen supplying layer 2 has a function of supplying oxygen or air taken in through the opening portion 8, to the diffusion layer 3. The oxygen supplying layer 2 also has a function of guiding water (water vapor) generated by the membrane electrode assembly 4 resulting from power generation, from the diffusion layer 3 to the opening portion 8 to discharge the water from the interior of the cell to the atmosphere. The oxygen supplying layer 2 meeting these conditions can be a porous member having a porosity of 80% or more and a hole diameter of 0.1 mm or more and be conductive. A specific material can be foam metal or stainless wool.

A material constituting the fuel supplying layer 6 can have an average aperture diameter of 100 to 900 μm. Fuel gas taken out of the fuel tank 10B diverges from a main channel of the fuel gas and is fed to the fuel supplying layer 6 in the fuel cell 10S. The fuel gas fed to the fuel supplying layer 6 diffuses through the diffusion layer 5. The fuel supplying layer 6 may be provided separately from the diffusion layer 5 or only the diffusion layer 5 may be provided such that a part of the diffusion layer 5 functions as the fuel supplying layer 6.

The diffusion layer 5 may be provided between the membrane electrode assembly 4 and the fuel supplying layer 6 or between the membrane electrode assembly 4 and the separator 7 in contact with both the membrane electrode assembly 4 and the separator 7. The diffusion layer 5 diffuses hydrogen gas used as a fuel, and collects surplus electrons resulting from ionization of hydrogen from the catalyst layer of the membrane electrode assembly 4. The diffusion layer 3 is provided between the membrane electrode assembly 4 and the oxygen supplying layer 2 in contact with both the membrane electrode assembly 4 and the oxygen supplying layer 2. The diffusion layer 3 serves to diffuse oxygen and to supply the catalyst layer (oxygen electrode) of the membrane electrode assembly 4 with electrons required for electrode reaction in the catalyst layer (oxygen electrode). The diffusion layer 5 can be conductive and include a material having holes smaller than those in the fuel supplying layer 6. In the present invention, the structure of the diffusion layer refers to a material constituting the diffusion layer.

The phrase “the diffusion layer 5 includes a material having holes smaller than those in the fuel supplying layer 6” means that the average hole diameter of the material constituting the diffusion layer 5 is smaller than that of the material constituting the fuel supplying layer 6. Moreover, the average aperture diameter (hole diameter) of the material constituting the diffusion layer 5 is intermediate between the average aperture diameter of a material constituting the catalyst layer, which is a fuel electrode, and the average aperture diameter of a material constituting the fuel supplying layer. Consequently, the fuel supplying layer 6 functions as throttling resistance and supplies fuel gas at a uniform current density while exerting uniform pressure on the entire surface of the membrane electrode assembly 4.

The diffusion layer 3 also includes a material having conductivity and having holes smaller than those in the oxygen supplying layer 2. The average aperture diameter of the material constituting the diffusion layer 3 is larger than that of the material constituting the catalyst layer, which is the oxygen electrode, and smaller than that of the material constituting the oxygen supplying layer 2. Such an aperture diameter allows the oxygen supplying layer 2 to function as throttling resistance. The oxygen supplying layer 2 supplies oxygen to the entire surface of the membrane electrode assembly 4 at a uniform pressure and a uniform current density.

The holes in the diffusion layer 3 may be through-holes allowing the oxygen supplying layer 2 and the membrane electrode assembly 4 to communicate with each other. The dense through-holes in the diffusion layer 3 enable generated water remaining between the membrane electrode assembly 4 and the diffusion layer 3 to be sucked up into the oxygen supplying layer 2. Carbon paper or a carbon cloth can be used as a material constituting the diffusion layers 3 and 5.

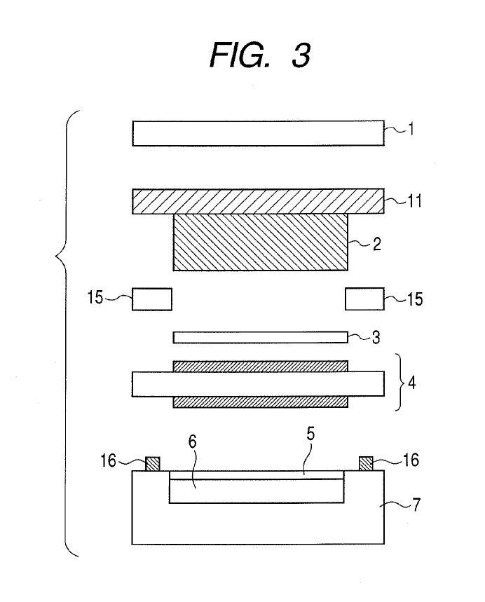

As illustrated in FIG. 2, the membrane electrode assembly 4 includes an electrolyte membrane 12 and two catalyst layers 13 and 14 (a fuel electrode and an oxygen electrode, respectively) formed in contact with the respective surfaces of the electrolyte membrane. The electrolyte membrane may include any material provided that the electrolyte membrane enables protons to be conducted from the fuel supplying layer to the oxygen supplying layer. Among such electrolyte membranes, a solid polymer electrolyte membrane can be properly used. An example of the solid polymer electrolyte membrane is Nafion (trademark) manufactured by Dupont and which is a perfluoro carbon polymer having a sulfonic acid group.

Furthermore, the two catalyst layers 13 and 14 include at least a substance having a catalytic activity. If the material having the catalytic activity cannot be independently present, the catalyst layer may be formed by carrying the catalytic activity substance on a carrier. An example of the catalytic activity substance which is independently present is a platinum catalyst formed by sputtering and having a dendritic shape.

An example of the catalytic activity substance carried on the carrier is platinum carrying carbon particles. The catalyst layer may contain electron conductors such as carbon particles or proton conductors (polymer electrolyte material). The catalyst layer may be integrated with the electrolyte membrane by contacting the catalyst layer with the surface of the electrolyte membrane. However, provided that the catalyst layer contacts the electrolyte membrane and can thus deliver chemical species such as hydrogen ions to the electrolyte membrane, the catalyst layer and the electrolyte membrane need not be integrated into the membrane electrode assembly 4. Furthermore, the catalyst layer can have an average aperture diameter of 10 nm to 100 nm.

The water-absorbing layer 11 includes a water-absorbing material. The water-absorbing material constituting the water-absorbing layer 11 can be fibers not only absorbing water but also drying quickly. The water-absorbing material can further be more hydrophilic than the material of the oxygen supplying layer 2. The water-absorbing material is shaped like a sheet and is independent of the oxygen supplying layer 2. Since the material constituting the water-absorbing layer 11 is more hydrophilic than the material of the oxygen supplying layer 2, water migrates more easily from the oxygen supplying layer 2 to the water-absorbing layer 11.

Furthermore, in the present invention, the “water-absorbing material” can suck up water based on the capillary phenomenon. More specifically, the “water-absorbing material” immersed into water sucks water up to a height of 30 mm or higher after the immersion for 10 seconds.

Additionally, the “quick-drying material” is capable of easily drying and emitting sucked water. More specifically, the “quick-drying material” exhibits a dryness factor of 80% or more after wetting in an atmosphere at 25° C. and at a relative humidity of 50% for one hour. Here, the dryness factor is the ratio of the weight of water remaining in the water-absorbing layer after the water-absorbing layer has been left in a thermo-hygrostat bath in a draught free environment for one hour, to the weight of water sucked into the water-absorbing layer based on the capillary phenomenon. For example, if the weight of water-absorbing fibers is 0.5 g and the total weight of the water-absorbing fibers after the suction based on the capillary phenomenon is 1.5 g, the weight of water sucked is 1 g. Furthermore, if the total weight of the water-absorbing fibers left in the thermo-hygrostat bath at 25° C. and at a humidity of 50% in the draught free environment for one hour is 0.6 g, the weight of the water remaining in the water-absorbing fibers is 0.1 g, and the weight of the evaporated water is 0.9 g. Since 0.9 g of the 1-g water is evaporated, the dryness factor is 90%.

An example of such a material absorbing water and drying quickly is a porous material having a hydrophilic surface. In the present invention, the “hydrophilic material” means that a water droplet formed on the material has a contact angle of 90° or less.

The water-absorbing layer 11 has roughly two functions.

A first function of the water-absorbing layer 11 is to absorb water generated in the oxygen supplying layer 2 to establish an oxygen diffusing channel in the oxygen supplying layer 2. Water generated in the membrane electrode assembly 4 in association with a power generation activity is discharged to the oxygen supplying layer 2 through the diffusion layer 3, installed outside the membrane electrode assembly 4. If the water-absorbing layer 11 is not provided, the generated water discharged to the oxygen supplying layer 2 is only removed by evaporation and diffusion (emission) through the opening portion 8 to the exterior of the cell. The generated water discharged to the oxygen supplying layer 2 cannot be sufficiently evaporated only by the natural diffusion from the oxygen supplying layer 2. In this case, the oxygen diffusing channel in the oxygen supplying layer 2 is narrowed and the partial pressure of the water vapor in the oxygen supplying layer 2 is increased. This hinders the flow of the generated water or water vapor discharged to the oxygen supplying layer 2 through the diffusion layer 3. That is, an excessively increased amount of moisture in the oxygen supplying layer 2 prevents the moisture from being discharged from the membrane electrode assembly 4 through the diffusion layer 3. Thus, the surface of the membrane electrode assembly 4 may be partly flooded. This hinders the oxygen supply to the membrane electrode assembly 4.

If the water-absorbing layer 11 including the water-absorbing material is provided, water vapor and fog drips are positively collected from the oxygen supplying layer 2 based on the capillary phenomenon in the water-absorbing layer 11. Thus, generated water is formed in the water-absorbing layer 11. Consequently, even if the hole diameter of the oxygen supplying layer 2 is too large or the porosity is high to cause the capillary phenomenon, the capillary phenomenon in the water-absorbing layer 11 allows the generated water in the oxygen supplying layer 2 to be taken into the water-absorbing layer 11. That is, water-absorbing layer 11 can reduce the hindrance to the supply of oxygen and the discharge of water vapor through the opening portion 8.

A second function of the water-absorbing layer 11 is to maintain the humidity in the oxygen supplying layer 2 constant.

An insufficient amount of moisture in the membrane electrode assembly 4 may cause a dry-out phenomenon in which the electrolyte membrane dries to prevent the conduction of hydrogen ions. Thus, the humidity in the fuel cell 10S is desirably maintained at an appropriate temperature. The presence of the water-absorbing layer 11 maintains the humidity constant. Consequently, if the membrane electrode assembly 4 dries, water evaporated from the water-absorbing layer 11 is absorbed by the electrolyte membrane. That is, the water-absorbing layer 11 prevents not only the flooding but also the dry-out phenomenon in an extremely dry condition or an out-of-operation condition to hold the interior of the fuel cell 10S at the appropriate humidity.

When the water-absorbing layer 11 is placed in the groove in the oxygen supplying layer 2, the water-absorbing layer 11 can be thinner than the oxygen supplying layer 2 so as to prevent the water-absorbing layer 11 from hindering the diffusion of the oxygen in the oxygen supplying layer 2. For example, when the oxygen supplying layer 2 has a thickness of 1 mm or more and 3 mm or less, the water-absorbing layer 11 can have a thickness of 1 μm or more and less than 1 mm.

As described above, the current collector 1 functions both as a partition (separator) for the adjacent fuel cells 10S and as a current collector that collects power. Thus, the current collector 1 is sometimes referred to as the separator. If the current collector 1 does not function as the separator and a separate separator is provided, the separator is formed opposite the oxygen supplying layer 2 across the current collector 1.

The separator 7 is sealed such that an area through which fuel gas, a fuel for the fuel cells 10S, passes is prevented from communicating with the open air. The fuel supplying layer 6 and the diffusion layer 5 are provided between the separator 7 and the membrane electrode assembly 4. In the present exemplary embodiment, the separator also functions as a current collector.

A water-absorbing layer 11-side surface of the current collector 1 may be subjected to a special surface treatment to enhance hydrophilicity. Examples of such a method include the application of a hydrophilic coating compound to the current collector 1, the use of a very hydrophilic material for the current collector 1, the formation of a sandblast process layer on the surface of the current collector 1, and the sputter coating of the current collector 1 with titanium oxide and silicon oxide. Of course, with such a method, liquid water condenses on and infiltrates and diffuses along the surface.

### Second Exemplary Embodiment

A fuel cell and a fuel cell system according to the present exemplary embodiment are similar to those according to the first exemplary embodiment except for the shape of the oxygen supplying layer.

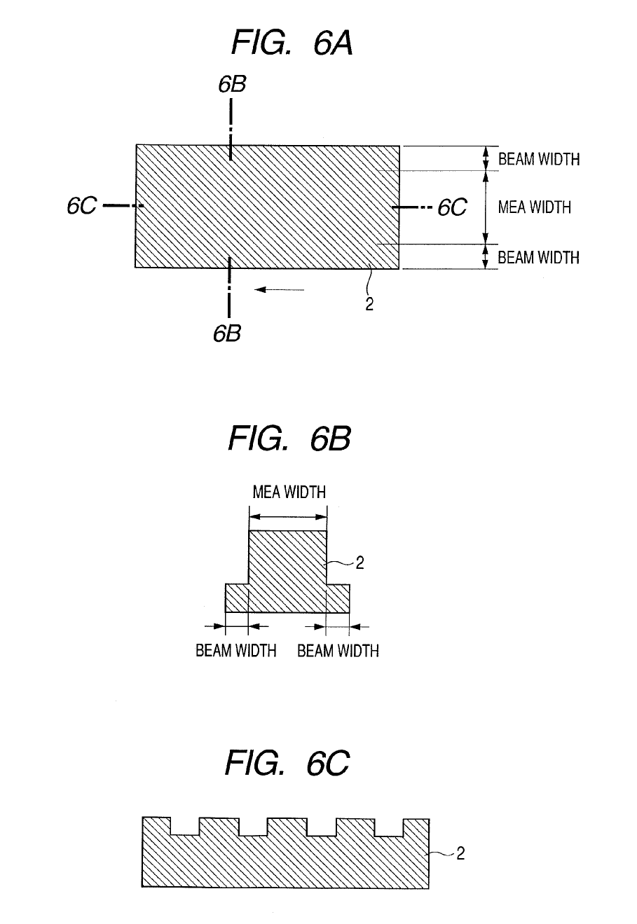

FIGS. 6A to 6C illustrate the oxygen supplying layer according to the present exemplary embodiment. FIG. 6A is a projection view illustrating that the oxygen supplying layer is irradiated with light from the direction of the current collector. FIG. 6B is a sectional view of a part of the oxygen supplying layer 2 illustrated in FIG. 6A which contacts the water-absorbing layer 11; the sectional view is taken along a surface (a cross section 6B-6B in FIG. 6A) perpendicular to the plane including the opening portion. FIG. 6C is a sectional view of the oxygen supplying layer 2 according to the present exemplary embodiment taken along a surface (a cross section 6C-6C in FIG. 6A) parallel to the plane including the opening portion and including the symmetry point of the oxygen supplying layer 2.

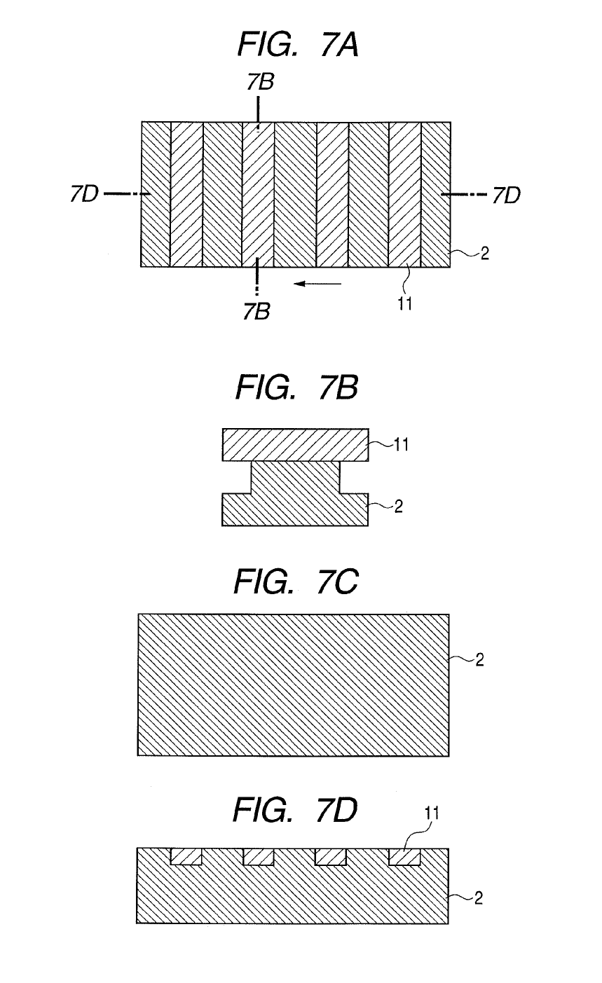

FIGS. 7A to 7D are diagrams illustrating the oxygen supplying layer 2 and the water-absorbing layer 11 placed on the oxygen supplying layer 2. FIG. 7A is a projection view illustrating that the oxygen supplying layer 2 and the water-absorbing layer 11 are irradiated with light from the direction of the current collector 1. FIG. 7B is a sectional view of the oxygen supplying layer 2 and the water-absorbing layer 11 in FIG. 7A taken along a surface (a cross section 7B-7B in FIG. 7A) which is perpendicular to the plane including the opening portion and which includes the water-absorbing layer. FIG. 7C is a projection view illustrating that the oxygen supplying layer 2 and the water-absorbing layer 11 are irradiated with light from the direction of the diffusion layer 3. FIG. 7D is a sectional view of the oxygen supplying layer 2 and the water-absorbing layer 11 taken along a surface (a cross section 7D-7D in FIG. 7A) parallel to the plane including the opening portion 8.

The oxygen supplying layer 2 according to the present exemplary embodiment has a shape that can be formed by the following method. As illustrated in FIG. 6B, an oxygen supplying layer precursor layer C is obtained from the oxygen supplying layer precursor layer A according to the first exemplary embodiment as follows. A plurality of areas enclosed by the following surfaces are cut from the parts of oxygen supplying layer precursor layer A other than those located opposite the membrane electrode assembly: a surface parallel to the plane including the opening portion, one side surface of the oxygen supplying layer precursor layer which is parallel to the opening portion, two surfaces perpendicular to the plane including the opening portion and parallel to the proton conduction direction, and a surface perpendicular to the plane including the opening portion and to the proton conduction direction. Then, the oxygen supplying layer 2 is obtained from the oxygen supplying layer precursor layer C as follows. A plurality of areas enclosed by the following surfaces are cut from the parts of oxygen supplying layer precursor layer C other than those located opposite the membrane electrode assembly: the surface parallel to the plane including the opening portion, the other side surface of the oxygen supplying layer precursor layer which is parallel to the opening portion, the two surfaces perpendicular to the plane including the opening portion and parallel to the proton conduction direction, and the surface perpendicular to the plane including the opening portion and to the proton conduction direction.

As described above, the oxygen supplying layer 2 is produced by cutting the appropriate areas from the oxygen supplying layer precursor layer. However, an oxygen supplying layer initially having the above-described structure may be used instead of producing the oxygen supplying layer by cutting the appropriate areas from the oxygen supplying layer precursor layer. Furthermore, in the description, for convenience, the oxygen supplying layer precursor layer is assumed to be a rectangular parallelepiped but need not necessarily be such. If the oxygen supplying layer precursor layer is not a rectangular parallelepiped, the oxygen supplying layer is obtained by cutting a plurality of areas enclosed by the surface parallel to the plane including the opening portion, a surface of the oxygen supplying layer precursor layer which is closest to the opening portion, the two surfaces perpendicular to the plane including the opening portion and parallel to the proton conduction direction, and the surface perpendicular to the plane including the opening portion and to the proton conduction direction.

With this configuration, as is the case with the first exemplary embodiment, the length from one end portion to the other end portion of the part in which the oxygen supplying layer 2 contacts the water-absorbing layer 11 in the cross section of the oxygen supplying layer and the water-absorbing layer taken along the surface perpendicular to the plane including the opening portion is shorter than the length from one end portion to the other end portion of the water-absorbing layer including the contact part in the cross section, and is also shorter than the length from one end portion to the other end portion of the surface of the oxygen supplying layer 2 which contacts the diffusion layer 3, as illustrated in FIG. 7B.

### Third Exemplary Embodiment

A fuel cell and a fuel cell system according to the present exemplary embodiment are similar to those according to the first exemplary embodiment except for the shape of the oxygen supplying layer.

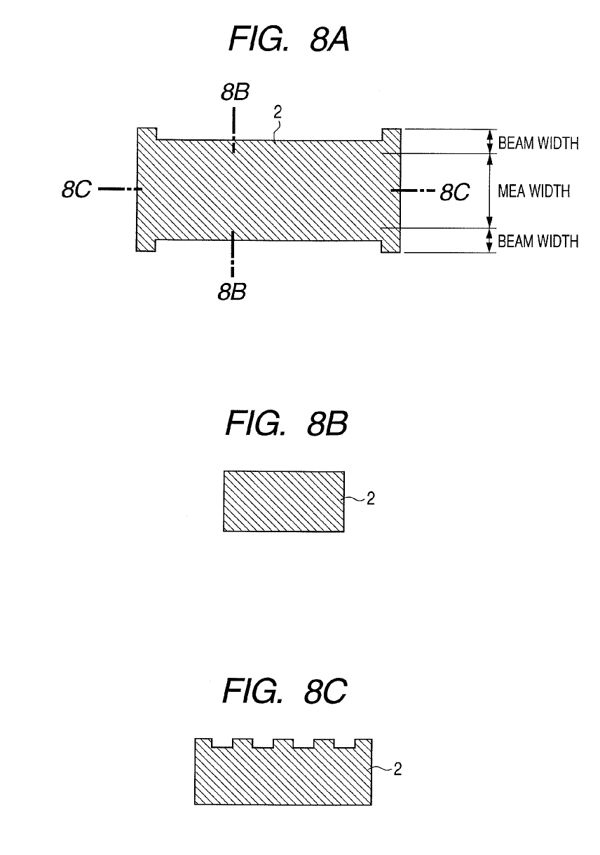

FIGS. 8A to 8C illustrate the oxygen supplying layer according to the present exemplary embodiment. FIG. 8A is a projection view illustrating that the oxygen supplying layer 2 is irradiated with light from the direction of the current collector 1. FIG. 8B is a sectional view of a part of the oxygen supplying layer in FIG. 8A which contacts the water-absorbing layer; the sectional view is taken along a surface (a cross section 8B-8B in FIG. 8A) perpendicular to the plane including the opening portion. FIG. 8C is a sectional view of the oxygen supplying layer 2 in FIG. 8A taken along a surface (a cross section 8C-8C in FIG. 8A) parallel to the plane including the opening portion and including the symmetry point of the oxygen supplying layer 2.

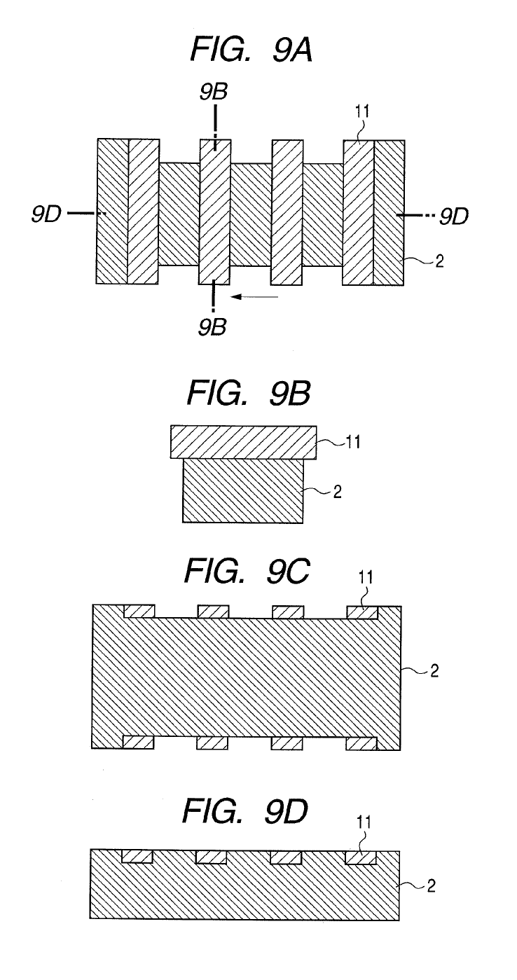

FIGS. 9A to 9D are diagrams illustrating the oxygen supplying layer 2 and the water-absorbing layer 11 according to the present exemplary embodiment. FIG. 9A is a projection view illustrating that the oxygen supplying layer 2 and the water-absorbing layer 11 are irradiated with light from the direction of the current collector 1. FIG. 9B is a sectional view of the oxygen supplying layer 2 and water-absorbing layer 11 illustrated in FIG. 9A; the sectional view is taken along a surface (a cross section 9B-9B in FIG. 9A) which is perpendicular to the plane including the opening portion and which includes the water-absorbing layer. FIG. 9C is a projection view illustrating that the oxygen supplying layer 2 and the water-absorbing layer 11 are irradiated with light from the direction of the diffusion layer 3. FIG. 9D is a sectional view of the oxygen supplying layer 2 and water-absorbing layer 11 illustrated in FIG. 9A; the sectional view is taken along a surface (a cross section 9D-9D in FIG. 9A) which is parallel to the plane including the opening portion and which includes the symmetry point of the oxygen supplying layer 2.

The oxygen supplying layer 2 according to the present exemplary embodiment has a shape that can be formed by the following method.

An oxygen supplying layer precursor layer D is obtained from the oxygen supplying layer precursor layer A, which is shaped like a rectangular parallelepiped, as follows. One area enclosed by the following surfaces are cut from the parts of oxygen supplying layer precursor layer A other than those located opposite the membrane electrode assembly: a surface parallel to the plane including the opening portion, two surfaces perpendicular to the plane including the opening portion and parallel to the proton conduction direction, and one side surface of the oxygen supplying layer precursor layer which is parallel to the opening portion. Then, the oxygen supplying layer 2 is obtained from the oxygen supplying layer precursor layer D as follows. One area enclosed by the following surfaces are cut from the parts of oxygen supplying layer precursor layer D other than those located opposite the membrane electrode assembly: the surface parallel to the plane including the opening portion, the two surfaces perpendicular to the plane including the opening portion and parallel to the proton conduction direction, and the other side surface of the oxygen supplying layer precursor layer which is parallel to the opening portion. In the description, for convenience, the oxygen supplying layer precursor layer A is assumed to be a rectangular parallelepiped but need not necessarily be such. If the oxygen supplying layer precursor layer is not a rectangular parallelepiped, the oxygen supplying layer is obtained by cutting one area enclosed by the surface parallel to the plane including the opening portion, two surfaces perpendicular to the plane including the opening portion, and a surface of the oxygen supplying layer precursor layer which is closest to the opening portion. Furthermore, to clarify the shape of the oxygen supplying layer 2, the description states that the oxygen supplying layer 2 is produced by cutting the appropriate area from the oxygen supplying layer precursor layer. However, an oxygen supplying layer initially having the above-described structure may be used instead of producing the oxygen supplying layer by cutting the appropriate area from the oxygen supplying layer precursor layer.

With this configuration, as is the case with the first exemplary embodiment, the length from one end portion to the other end portion of the part in which the oxygen supplying layer 2 contacts the water-absorbing layer 11 in the cross section of the oxygen supplying layer and the water-absorbing layer taken along the surface perpendicular to the plane including the opening portion is shorter than the length from one end portion to the other end portion of the water-absorbing layer including the contact part in the cross section, as illustrated in FIG. 9B.

In the present exemplary embodiment, as illustrated in FIG. 8A, when the direction of the oxygen supplying layer precursor layer A perpendicular to the plane including the opening portion, that is, the width direction of the precursor layer A, is cut off from the side surface of the oxygen supplying layer precursor layer A which is parallel to the plane including the opening portion, the precursor layer A can be cut off over a width smaller than that (beam width) over which the beam is pressurized. This is because if the oxygen supplying layer precursor layer is cut off over the same width as the beam width, sufficient sealability may fail to be ensured. Furthermore, it is possible to avoid cutting off the end portion of a side surface of the oxygen supplying layer precursor layer A which is located close to one of the side surfaces of the precursor layer A which is perpendicular to the plane including the opening portion. This is because avoiding cutting off the vicinity of the end portion allows the beam portion to be pressurized by the uncut portion, ensuring sufficient sealability.

### Fourth Exemplary Embodiment

A fuel cell and a fuel cell system according to the present exemplary embodiment are similar to those according to the first exemplary embodiment except for the shape of the oxygen supplying layer.

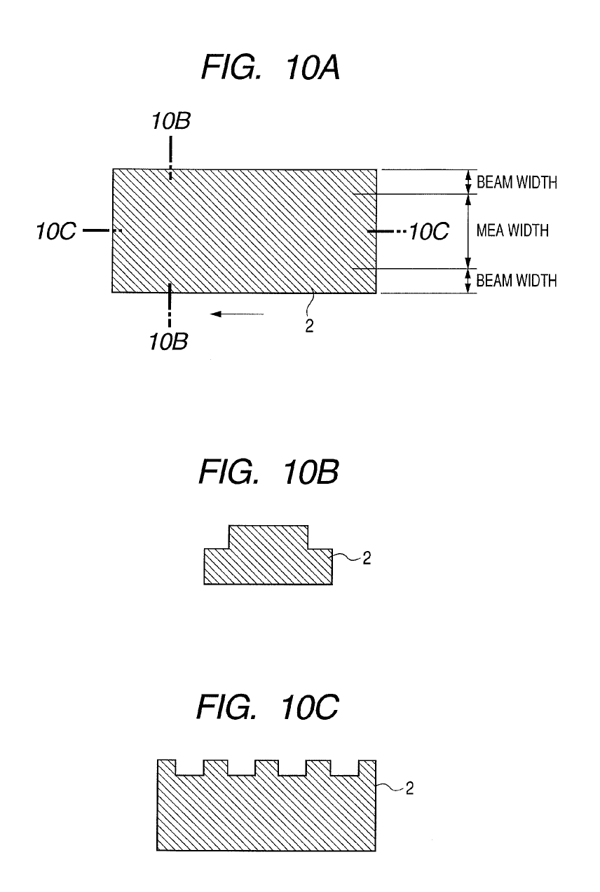

FIGS. 10A to 10C illustrate the oxygen supplying layer according to the present exemplary embodiment. FIG. 10A is a projection view illustrating that the oxygen supplying layer 2 according to the present exemplary embodiment is irradiated with light from the direction of the current collector. FIG. 10B is a sectional view of a part of the oxygen supplying layer in FIG. 10A which contacts the water-absorbing layer; the sectional view is taken along a surface (a cross section 10B-10B in FIG. 10A) perpendicular to the plane including the opening portion. FIG. 10C is a sectional view of the oxygen supplying layer 2 taken along a surface (a cross section 10C-10C in FIG. 10A) parallel to the plane including the opening portion and including the symmetry point of the oxygen supplying layer 2.

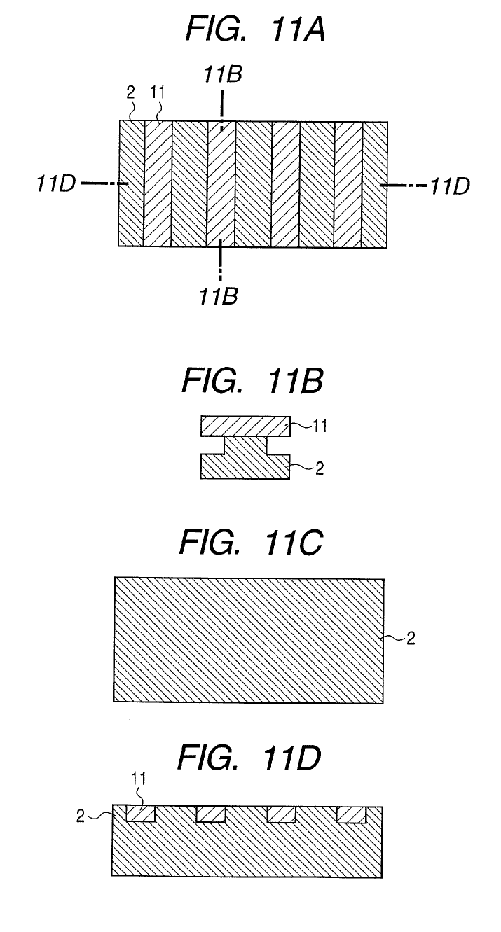

FIGS. 11A to 11D are diagrams illustrating the oxygen supplying layer 2 and the water-absorbing layer 11 according to the present exemplary embodiment. FIG. 11A is a projection view illustrating that the oxygen supplying layer 2 and the water-absorbing layer 11 are irradiated with light from the direction of the current collector 1. FIG. 11B is a sectional view of the oxygen supplying layer 2 and water-absorbing layer 11 illustrated in FIG. 11A; the sectional view is taken along a surface (a cross section 11B-11B in FIG. 11A) which is perpendicular to the plane including the opening portion and which includes the water-absorbing layer. FIG. 11C is a projection view illustrating that the oxygen supplying layer 2 and the water-absorbing layer 11 are irradiated with light from the direction of the diffusion layer 3. FIG. 11D is a sectional view of the oxygen supplying layer 2 and water-absorbing layer 11 illustrated in FIG. 11A; the sectional view is taken along a surface (a cross section 11D-11D in FIG. 11A) which is parallel to the plane including the opening portion and which includes the symmetry point of the oxygen supplying layer 2.

The oxygen supplying layer 2 according to the present exemplary embodiment has a shape that can be formed by the following method. The oxygen supplying layer precursor layer D is obtained from the oxygen supplying layer precursor layer A, which is shaped like a rectangular parallelepiped, as follows. One area enclosed by the following surfaces are cut from the parts of oxygen supplying layer precursor layer A other than those located opposite the membrane electrode assembly: a surface parallel to the plane including the opening portion, two surfaces perpendicular to the plane including the opening portion and parallel to the proton conduction direction, one side surface of the oxygen supplying layer precursor layer which is parallel to the opening portion, and a surface perpendicular to the plane including the opening portion and to the proton conduction direction. Then, the oxygen supplying layer 2 is obtained from the oxygen supplying layer precursor layer D as follows. One area enclosed by the following surfaces are cut from the parts of oxygen supplying layer precursor layer D other than those located opposite the membrane electrode assembly: the surface parallel to the plane including the opening portion, two surfaces perpendicular to the plane including the opening portion and which are parallel to the proton conduction direction, the other side surface of the oxygen supplying layer precursor layer which is parallel to the opening portion, and the surface perpendicular to the plane including the opening portion and to the proton conduction direction. In the description, for convenience, the oxygen supplying layer precursor layer is assumed to be a rectangular parallelepiped but need not necessarily be such. If the oxygen supplying layer precursor layer is not a rectangular parallelepiped, the oxygen supplying layer is obtained by cutting one area enclosed by the surface parallel to the plane including the opening portion, two surfaces perpendicular to the plane including the opening portion, a surface of the oxygen supplying layer precursor layer which is closest to the opening portion, and the surface perpendicular to the plane including the opening portion and to the proton conduction direction. Furthermore, to clarify the shape of the oxygen supplying layer 2, the description states that the oxygen supplying layer 2 is produced by cutting the appropriate area from the oxygen supplying layer precursor layer. However, an oxygen supplying layer initially having the above-described structure may be used instead of producing the oxygen supplying layer by cutting the appropriate area from the oxygen supplying layer precursor layer.

With this configuration, as is the case with the first exemplary embodiment, the length from one end portion to the other end portion of the part in which the oxygen supplying layer 2 contacts the water-absorbing layer 11 in the cross section of the oxygen supplying layer and the water-absorbing layer taken along the surface perpendicular to the plane including the opening portion is shorter than the length from one end portion to the other end portion of the water-absorbing layer including the contact part in the cross section, and is also shorter than the length from one end portion to the other end portion of the surface of the oxygen supplying layer 2 which contacts the diffusion layer 3, as illustrated in FIG. 11B.

### Examples

### Example 1

In the present examples, the oxygen supplying layer described in the first exemplary embodiment and illustrated in FIGS. 4A to 4C was used. The water-absorbing layer was placed on the oxygen supplying layer as illustrated in FIGS. 5A to 5E. With this configuration, even though the water-absorbing layer does not stick out from the cell, the area can be increased over which the end portion of the water-absorbing layer is exposed to the atmosphere. Thus, the evaporability can be improved.

The width of the oxygen supplying layer in the cross section of the fuel cell taken along the surface perpendicular to the plane including the opening portion and parallel to the proton conduction direction was the same as that of the membrane electrode assembly in the cross section. In FIG. 4A, the portion of the oxygen supplying layer precursor layer in which the cut-off portion γ was present before the cutting was a part of the seal portion on the outer periphery of the cell.

A method of producing the fuel cell according to the present example will be described below.

### (Step 1)

A platinum oxide catalyst having a dendritic structure was formed on a PTFE sheet (NITOFLON manufactured by NITTO DENKO CORPORATION) to a thickness of 2,000 nm by reactive sputtering; the PTFE sheet corresponded to a transfer layer to be transferred to the electrolyte membrane. At this time, the amount of Pt carried was measured to be 0.68 mg/cm² by means of XRF. The reactive sputtering was performed at a total pressure of 4 Pa, an oxygen flow rate (Q₀₂/(Q_{Ar}+Q_{O2})) of 70%, a substrate temperature of 300° C., and an input power of 4.9 W/cm². A reduction treatment was subsequently carried out on the platinum oxide catalyst having the dendritic structure in a 2% H₂/He atmosphere (1 atm) at 120° C. for 30 minutes. A platinum catalyst layer having a dendritic structure was thus obtained on the PTFE sheet.

Moreover, the PTFE sheet was impregnated with a mixed suspension of PTFE and Nafion (registered trademark) to effectively form an electrolytic channel on the surface of the catalyst. The PTFE sheet was further subjected to an appropriate water-repellent treatment.

### (Step 2)

A doctor blade was used to form a platinum-carrying carbon catalyst on a PTFE sheet corresponding to a transfer layer to be transferred to the electrolyte membrane. A catalyst slurry used was a kneaded substance of platinum-carrying carbon (HiSPEC4000 manufactured by Jhonson Matthey), Nafion, PTFE, IPA, and water. The amount of platinum carried was measured to be 0.35 mg/cm² by means of XRF.

### (Step 3)

The catalyst layer produced in (Step 1) was used as an oxygen electrode, and the catalyst layer produced in (Step 2) was used as a fuel electrode. A solid polymer electrolyte membrane (Nafion 112 manufactured by Dupont) was sandwiched between the pair of catalyst layers (oxygen electrode and fuel electrode). The resulting structure was then subjected to hot press under press conditions including 8 MPa, 150° C., and 1 min.

Subsequently, the PTFE sheet was peeled off to transfer the pair of catalyst layers to the polymer electrolyte membrane. A membrane electrode assembly was thus obtained which included the electrolyte membrane and the pair of catalyst layers joined together.

### (Step 4)

Foam metal of length 28 mm, width 10 mm, and thickness 2 mm was used as an oxygen supplying layer precursor layer. An end portion plate had a length of 37 mm and a width of 10 mm, which were set to be the length and width of the cell. Four grooves each of length 10 mm, width 2.5 mm, and depth 500 μm were formed at equal intervals on one surface of the oxygen supplying layer precursor layer, that is, on a side of the oxygen supplying layer precursor layer which contacted the oxygen electrode-side current collector; the grooves extended in a direction parallel to the 10-mm width of the oxygen supplying layer precursor layer. The laterally opposite end portions of each of the grooves were each cut off by 1.3 mm to form a through-hole. The oxygen supplying layer illustrated in FIG. 4A was thus obtained. Recessed and protruding portions resulting from the cut-off do not contact the diffusion layer in the oxygen supplying layer, which is located closer to the oxygen electrode. The recessed and protruding portions further pressurize the beam, a support member of the cell. That is, the diffusion layer contacts a central portion of the foam metal and is pressurized by the central portion. However, the beam of the support member is pressurized by the missing portions (the portions μ in FIG. 4A) of the foam metal.

A water-absorbing material of length 10 mm, width 2.5 mm, and thickness 500 μm formed by cutting was installed in each of the grooves of the oxygen supplying layer so as not to stick out from the cell. The water-absorbing material was used as a water-absorbing layer. Here, a liquid-diffusing non-woven cloth P type manufactured by AMBIC CO., LTD. was used as the water-absorbing material.

### (Step 5)

The following components obtained as described above were stacked as illustrated in FIG. 3 to obtain a fuel cell: the membrane electrode assembly, the junction of the oxygen supplying layer and the water-absorbing layer, the fuel electrode-side current collector, the fuel electrode-side diffusion layer, the oxygen electrode-side diffusion layer, and the oxygen electrode-side current collector. The fuel electrode-side current collector in the present example corresponds to the separator 7 in FIG. 3. Furthermore, in the present example, a part of the fuel electrode-side diffusion layer functions as a fuel supply layer.

Additionally, a carbon cloth (LT2500-W manufactured by E-TEK) was used as the fuel electrode-side diffusion layer. A carbon cloth (LT1200-W manufactured by E-TEK) was used as the oxygen electrode-side diffusion layer.

### Comparative Example

Comparative Example was similar to Example 1 except that an oxygen supplying layer precursor layer with uncut end portions was used as the oxygen supplying layer for Step 4 of Example 1 and the end portions of the water-absorbing layer were located on the fuel cell-side with respect to the plane including the opening portion. As in the case of Example 1, grooves in which the water-absorbing layer was installed were formed in the oxygen supplying layer. The size of the water-absorbing layer is similar to that in Example 1 except the length of the water-absorbing layer in Comparative Example is 5 mm. The location of the grooves is similar to that in Example 1, and the water-absorbing layer was installed in a central portion of each of the grooves. That is, the opposite end portions of the water-absorbing layer were each located 5 mm inward of the plane including the opening portion.

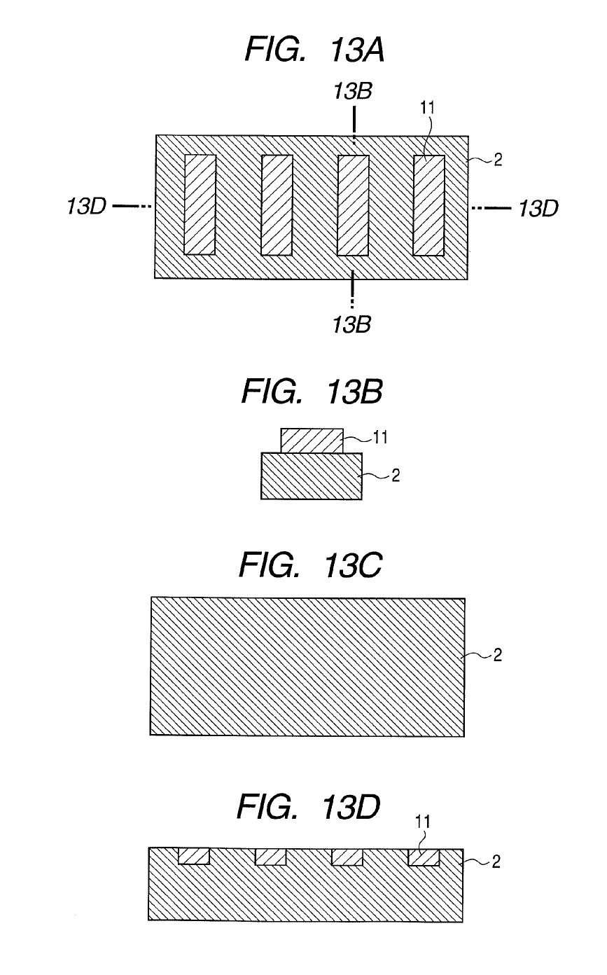

FIGS. 13A to 13D illustrate the oxygen supplying layer 2 and water-absorbing layer 11 used. FIG. 13A is a projection view illustrating that the oxygen supplying layer 2 and the water-absorbing layer 11 are irradiated with light from the direction of the current collector. FIG. 13B is a sectional view of the oxygen supplying layer 2 and water-absorbing layer 11 in FIG. 13A; the sectional view is taken along a surface (a cross section 13B-13B in FIG. 13A) which is perpendicular to the plane including the opening portion and which includes the water-absorbing layer. FIG. 13C is a projection view illustrating that the oxygen supplying layer 2 and the water-absorbing layer 11 are irradiated with light from the direction of the gas diffusion layer 3. FIG. 13D is a sectional view of the oxygen supplying layer 2 and water-absorbing layer 11 illustrated in FIG. 13A; the sectional view is taken along a surface (a cross section 13D-13D in FIG. 13A) which is parallel to the plane including the opening portion and which includes the symmetry point of the oxygen supplying layer 2.

Fuel cells produced as described above were evaluated for a flooding resistance property by measuring a variation in voltage at a constant current of 400 mA/cm². Measurement conditions were such that the cells were placed in a thermo-hygrostat bath in a draught free environment at 25° C. and at a relative humidity of 50% and evaluated using natural intake air and without using any auxiliary device such as a compressor.

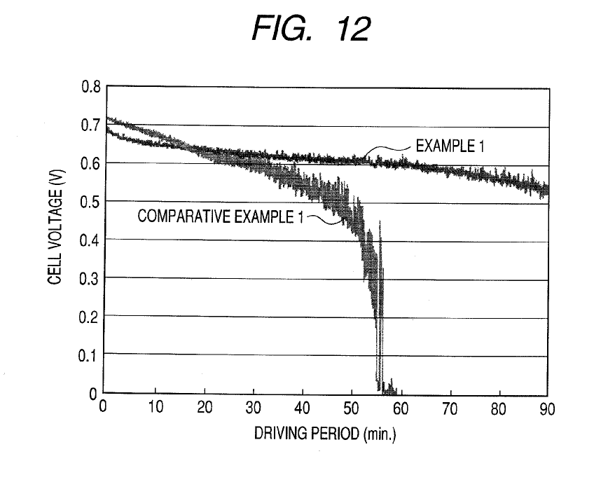

FIG. 12 illustrates the results of evaluation of the fuel cells in Example 1 and Comparative Example. During an initial period of driving, both cells exhibited similar voltages. However, 60 minutes after the start of the driving, the cell in Comparative Example exhibited a cell voltage of 0 V and stopped. This is expected to be because the oxygen supplying layer was flooded with generated water. In contrast, the cell in Example 1 did not exhibit a significant voltage drop even 90 minutes after the start of the driving.

Then, a discharge function was compared based on the weight of water remaining in both fuel cells 90 minutes after the start of the constant current measurement. As a result, the amount of water remaining in the cell in Comparative Example was 209 mg, whereas the amount of water remaining in the cell in Example 1 exhibited a small value of 78 mg.

These results indicate that the fuel cell in Example 1 has a function of efficiently discharging generated water to the exterior of the cell and a function of inhibiting possible flooding. This has enabled the provision of a cell having an excellent discharging function and a high flooding resistance in spite of a small size without the need to stick the water-absorbing layer out from the cell.

Furthermore, fuel cells described in Examples 2 and 3 illustrated below can be produced and used.

### Example 2

In the present example, the oxygen supplying layer described in the third exemplary embodiment and illustrated in FIGS. 8A to 8C is used. The water-absorbing layer is placed on the oxygen supplying layer as illustrated in FIGS. 9A to 9D. Example 2 is similar to Example 1 except that the water-absorbing layer and oxygen supplying layer illustrated in FIGS. 8A and 9A are used.

That is, Example 2 is an example of a fuel cell using the oxygen supplying layer obtained by cutting off the end portions of the oxygen supplying layer precursor layer over a width smaller than the beam width of the support member so that the end portions penetrate the oxygen supplying layer in the proton conduction direction and in the direction perpendicular to the proton conduction direction. For example, the oxygen supplying layer can be obtained by cutting off the end portions of the oxygen supplying layer precursor layer over 0.65 mm, which is half the beam width of the support member.

In this configuration, the water-absorbing layer is exposed to the atmosphere not only in the proton conduction direction but also in the direction perpendicular to the proton conduction direction. As a result, proper evaporability can be ensured.

### Example 3

In the present example, the oxygen supplying layer described in the second exemplary embodiment and illustrated in FIGS. 6A to 6C is used. The water-absorbing layer is placed on the oxygen supplying layer as illustrated in FIGS. 7A to 7D. This configuration enables an increase in the area over which the end portions of the water-absorbing layer are exposed to the atmosphere even without the need to stick the water-absorbing layer out from the cell. The evaporability can thus be improved.

Example 3 is similar to Example 1 except that the water-absorbing layer and oxygen supplying layer illustrated in FIGS. 6A and 7A are used. For example, the depth width can be 1.3 mm, like the beam width of the support member, and the depth can be 1.5 mm. Since the thickness of the oxygen supplying layer is 2 mm, the beam portion of the support member is pressurized by the oxygen supplying layer of thickness 0.5 mm.

In the fuel cell configured as described above, the entire beam portion can be pressurized even when the beam portion does not have a sufficient strength, enabling sufficient sealability to be ensured. Furthermore, the water-absorbing layer is exposed to the atmosphere in the direction perpendicular to the proton conduction direction, thus ensuring proper evaporability. Moreover, when the depth in the proton conduction direction of areas communicating with each other in the direction perpendicular to the proton conduction direction is set greater than that of the groove in which the water-absorbing layer is located, the water-absorbing layer is also exposed to the atmosphere in the proton conduction direction. As a result, more proper evaporability can be ensured.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2007-201793, filed Aug. 2, 2007 and 2008-162304, filed Jun. 20, 2008, which are hereby incorporated by reference in their entirety.

1. A fuel cell comprising:
a membrane electrode assembly comprising an electrolyte membrane and two catalyst layers located opposite each other across the electrolyte membrane;
two diffusion layers located opposite each other across the membrane electrode assembly;
an oxygen supplying layer contacting one of the two diffusion layers;
a water-absorbing layer contacting the oxygen supplying layer;
a current collector contacting the oxygen supplying layer; and
an opening portion in a part of a side surface of the fuel cell, which is parallel to a proton conduction direction of the electrolyte membrane,
wherein the water-absorbing layer is provided between the oxygen supplying layer and the current collector,
wherein an end portion of the water-absorbing layer is located on a plane including the opening portion or on a fuel cell-side with respect to the plane, and
wherein a length from one end portion to another end portion of a part of the oxygen supplying layer, which contacts the water-absorbing layer in a cross section of the fuel cell taken along a surface, which includes the water-absorbing layer and which is perpendicular to the plane, is smaller than a length from the one end portion to another end portion of the water-absorbing layer including a part of the water-absorbing layer, which contacts the oxygen supplying layer in the cross section.

2. The fuel cell according to claim 1, wherein the length from the one end portion to the another end portion of the part of the oxygen supplying layer, which contacts the water-absorbing layer in the cross section, is equal to or greater than a length of the membrane electrode assembly in a direction perpendicular to the plane including the opening portion in the cross section.

3. The fuel cell according to claim 1, wherein the length from the one end portion to the another end portion of the part of the oxygen supplying layer, which contacts the water-absorbing layer in the cross section, is smaller than a length from one end portion to another end portion of a part of the oxygen supplying layer, which contacts the current collector in the cross section.

4. A fuel cell system comprising a plurality of stacked fuel cells, wherein the fuel cells comprise the fuel cell according to claim 1.
